(19) United States
(12) Patent Application Publication
(10) Pub. No.: US 2020/0003163 A1
(43) Pub. Date: Jan. 2, 2020

(54) PURGE SYSTEM

(71) Applicant: HELLA GmbH & Co. KGaA, Lippstadt (DE)

(72) Inventors: Ingo NIEMEYER, Moehnesee (DE); Ludger BUESCHER, Lippstadt (DE)

(73) Assignee: HELLA GmbH & Co. KGaA, Lippstadt (DE)

(21) Appl. No.: 16/564,723

(22) Filed: Sep. 9, 2019

Related U.S. Application Data
(63) Continuation of application No. PCT/EP2017/055259, filed on Mar. 7, 2017.

(51) Int. Cl. F02M 25/08

(52) U.S. Cl. CPC F02M 25/089; F02M 25/0827; F02M 25/0836

(57) ABSTRACT

A purge system of a vehicle for purging C—H-gas of a tank system to an induction line of a combustion engine of the vehicle. The purge system includes a purge unit, a control unit for operating the purge unit and gas connection lines, wherein a first line end of the gas connection lines is configured for connecting the purge unit with the tank system and a second line end of the gas connection lines is configured for connecting the purge unit with the induction line. The purge system also includes a C—H-sensor for measuring a C—H-gas concentration of a fluid volume flow that flows from the first line end towards the second line end. A vehicle and a method for operating a combustion engine system of a vehicle with a purge system is also provided.

This nonprovisional application is a continuation of International Application No. PCT/EP2017/055259, which was filed on Mar. 7, 2017, and which is herein incorporated by reference.

### BACKGROUND OF THE INVENTION

### Field of the Invention

The present invention relates to a purge system of a vehicle for purging C—H-gas of a tank system to an induction line of a combustion engine of the vehicle. Moreover, the invention relates to a vehicle with such purge pump system and a method for operating a purge pump system.

### Description of the Background Art

Vehicles with a combustion engine comprise a tank system for storing liquid fuel. For such fuel tank systems, evaporation of hydrocarbon gas within the tank system is an issue. By means of an activated carbon filter, evaporated hydrocarbon gas of the tank system is bound. The tank system further comprises a duct line, for forwarding the hydrocarbons to an induction line for providing the combustion engine with filtered oxygen mixed with the hydrocarbons. Generally, the transport of the hydrocarbons from the active carbon filter to the combustion engine is evoked by a negative pressure within the induction line. For controlling a volumetric flow of the hydrocarbons, a purge valve is provided between the induction line and the active carbon filter.

In some cases, the negative pressure of the induction line is not big enough for assuring a predetermined volumetric flow of the hydrocarbons. In order to overcome this drawback, a purge pump is provided between the active carbon filter and the purge valve. The purge pump is configured for the suction of fresh air via a separate air duct line through the active carbon filter, wherein, by these means, the fresh air is mixed with the hydrocarbons within the active carbon filter. The purge pump is further configured for the transport of the hydrocarbon-air-mixture to the induction line of the combustion engine. The purge pump is configured as a continuously operating pump, forwarding the hydrocarbon-air-mixture with a constant or at least substantially constant volumetric flow. In this case, the volumetric flow is still controlled by the purge valve. This has the advantage that a tank system architecture without such purge pump just needs minor adjustment for the integration of a purge pump. For ensuring a reliable continuous operation of the purge pump, standard purge pumps are operated by a brushless DC motor.

However, conventional purge pump systems have the substantial drawback that the total amount of C—H-gas that is added to the combustion engine is unknown, because the percentage of C—H-gas that is fed through the purge system to the combustion engine is unknown. As a consequence, measurement data of the lambda probe have to be considered for readjusting the fuel injection process as well as the feeding of fresh air and purged C—H-gas. This process is time consuming and causes at least temporarily higher emissions and prevents an optimized purging process, especially with purge systems that do not comprise a purge pump. Purge systems without a purge pump just have a short time window for purging C—H-gas, namely when the combustion engine provides enough negative pressure within the induction line.

### SUMMARY OF THE INVENTION

It is therefore an object of the present invention to provide a purge system, a vehicle and a method for operating a combustion engine system that overcome or at least improve the drawbacks mentioned above. In particular, it is an object of the present invention, to provide a purge system, a vehicle and a method for operating a combustion engine system that have an improved combustion process and/or less fuel consumption and/or less emissions compared to state in the art solutions.

According to an exemplary embodiment of the invention, the object is solved by a purge system of a vehicle for purging C—H-gas of a tank system to an induction line of a combustion engine of the vehicle. The purge system comprises a purge unit, a control unit for operating the purge unit and gas connection lines. A first line end of the gas connection lines is configured for connecting the purge unit with the tank system and a second line end of the gas connection lines is configured for connecting the purge unit with the induction line. According to the invention, the purge system comprises a C—H-sensor for measuring a C—H-gas concentration of a fluid volume flow that flows from the first line end towards the second line end.

A purge unit is a subassembly of the purge system that is effecting a volume flow of a mixture of C—H-gas and air, e.g. by providing a respective pressure or by limiting a flow cross-section for the volume flow. The purge system comprises at least the purge unit and gas connection lines. The purge unit is adjustable by the control unit, e.g. with respect to a demand of volume flow of C—H-gas and/or an operation status of the combustion engine. Preferably, the control unit is further configured for controlling the combustion process of the combustion engine, such as the fuel injection and feeding of fresh air to the combustion engine. In other words, the control unit can be part of a motor control unit.

The tank system can comprise an active carbon filter for binding C—H-gas that evades from a tank of the tank system. The active carbon filter is preferably connected to a fresh air inlet that preferably comprises an air filter. A first line end of a gas connection line is configured for being connected to the tank system, especially to the active carbon filter, for connecting the purge unit with the tank system. In other words, the active carbon filter is preferably interconnected in between the tank and the purge unit, especially via a gas connection line. Thus, fresh filtered air can be sucked through the active carbon filter into the purge system towards the purge unit. In the active carbon filter, the fresh air can mix with C—H-gas that is bound within the active carbon filter. The second line end is configured for being connected to the induction line of the combustion engine for connecting the purge unit with the induction line. Thus, the mix of air and C—H-gas can be provided to the induction line.

The C—H-sensor is configured for measuring a C—H-gas concentration of a fluid volume flow that flows from the first line end towards the second line end. By these means, a volume flow of C—H-gas that is provided to the induction line can be determined. Alternatively or additionally, the C—H-sensor can be configured for measuring N2-gas concentration and/or O2-gas concentration. Based on these values, the C—H-gas concentration can be determined as well. According to the invention, at least one C—H-sensor is provided. However, two or more C—H-sensors may be provided, e.g. for generating redundant signals or for an early indication of a change of the C—H-gas concentration, e.g. due to a change of an amount of C—H-gas that is bound within the active carbon filter. Preferably, at least one C—H-gas filter is located near the first line end and at least one other C—H-gas filter is located near the second line end. Preferably, the C—H-sensor is configured for being connected to the control unit, wherein the control unit is configured for evaluating data from the C—H-sensor. According to the invention, the C—H-sensor can be configured for evaluating its measured data for determining the C—H-gas concentration.

The purge system of the invention has the advantage that due to the possibility of measuring the C—H-gas concentration of the fluid volume flow that flows from the first line end towards the second line end, an amount of C—H-gas provided to the combustion engine via the purge system can be determined. Thus, the amount of fuel injected into the combustion engine can be adjusted based on this information in order to operate the combustion engine with an optimized mixture of C—H-gas and air. Consequently, an additional optimization of the combustion process by means of the lambda probe requires less adjustment of fuel injection amount and air feeding. This has the advantage, that energy consumption and CO2 emissions can be reduced significantly. Moreover, by these means, the purge process can be further improved, since the time window for purging can be increased.

The purge unit can comprise a purge pump for purging C—H-gas from the first line end towards the second line end. The purge pump comprises a motor for driving the purge pump, e.g. a pump unit of the purge pump to pump fluid from the first gas connection line to the second gas connection line. By these means, C—H-gas from the active carbon filter can be pumped towards the induction line. A rotational speed of the motor is proportional to a volume flow of pumped C—H-gas. Preferably, the control unit is configured for operating the motor. The control unit is configured for providing and/or generating a current for effecting the relative rotation of a rotor of the motor to a stator of the motor. Preferably, the motor can be operated at frequently changing rotational speeds. Since the volume flow of the pumped C—H-gas is proportional to the rotational speed of the motor, by controlling the rotational speed of the motor, the volume flow can be controlled. The motor can be configured as brushless DC motor. Preferably, the control unit is configured to generate the commutative current for operating the motor. A brushless DC motor has the advantage of high reliability, less inner friction, low energy consumption and improved explosive protection. Thus, energy consumption and CO2 emissions can be further reduced. Moreover, due to the high reliability of the brushless DC motor, maintenance intervals of the purge pump system can be extended and, thus, maintenance costs can be reduced. A purge pump has the advantage that C—H-gas can be purged independently from an operational status of the combustion engine, e.g. when there is not enough negative pressure within the induction line.

The purge system can further comprise a check valve for preventing a fluid volume flow from the induction line towards the purge pump. The check valve is preferably a passive valve that blocks fluid volume flow from the induction line towards the purge pump and allows fluid volume flow from the purge pump towards the induction line. Preferably, the check valve is located at a gas connection line between the second line end and the purge pump. A check valve has the advantage, that a back volume flow of explosive gas in a direction from the induction line towards the tank system is prevented. Thus, the operation reliability and efficiency of the purge system is increased, while energy consumption and CO2 emissions can be further reduced.

The purge unit can comprise a purge valve for controlling a volume flow of C—H-gas from the first line end towards the second line end. Preferably, the control unit is configured for operating the purge valve. The purge valve is configured for adjusting a size of a flow cross-section for the mixture of C—H-gas and air. The purge valve is preferably configured for closing the gas connection line in case of system breakdown, e.g. a loss of connection to the control unit due to an accident. Moreover, a purge valve has the advantage of relatively low investment costs and high reliability during operation.

The C—H-sensor can be integrated in the purge pump or the check valve or the purge valve. With more C—H-sensors, it is preferred that the C—H-sensors are distributed over purge pump, check valve and the purge valve. It is preferred that at least purge pump comprises a C—H-sensor. The integration of C—H-sensors has the advantage that overall costs can be reduced, especially due to less necessary assembly steps. Furthermore, cables for the C—H-sensor and a purge unit, e.g. purge pump or purge valve, can be grouped to one main cable. Thus, the connection of these components to the control unit is simplified.

The purge unit can comprise a pressure sensor and/or a mass flow sensor for measuring a fluid pressure and/or a fluid mass flow inside the gas connection line between the purge unit and the first line end and/or a temperature sensor for measuring a temperature within the purge system. Preferably, the pressure sensor is configured for being connected to the control unit, wherein the control unit is configured for evaluating data from the pressure sensor. A pressure sensor can be used for detecting a leakage of a gas connection line. Moreover, with pressure sensors, the volume stream of the mix of air and C—H-gas can be determined. A temperature sensor has the advantage that temperature effects on the fluid mass flow can be considered.

The pressure sensor and/or the mass flow sensor and/or the temperature sensor can be integrated in the purge pump or the purge valve. The integration of pressure sensors, mass flow sensors and temperature sensors in a purge unit has the advantage that overall costs of the purge system can be reduced, especially due to less necessary assembly steps. Another advantage is a better protection of the sensor from the fluid mass flow. Furthermore, cables for the pressure sensor and the purge pump or the purge valve, can be grouped to one main cable. Thus, the connection of these components to the control unit is simplified.

The control unit can be configured to determine a C—H-gas volume flow that exits the second line end, based on the measured C—H-gas concentration and the fluid volume flow through the gas connection lines. The fluid volume flow can be determined by a rotational speed of the purge pump and/or measured fluid pressure within the gas connection lines in combination with a setting of the purge valve. By these means, a C—H-gas volume flow from the purge system into the induction line can be easily determined.

According to an exemplary embodiment, a vehicle is also provided with a combustion engine, a tank system for providing the combustion engine with fuel and an induction line for providing the combustion engine with oxygen. The vehicle comprises a purge system according to the invention.

The vehicle has the same advantages over the prior art as previously described with regard to the purge system according to the exemplary embodiment. Hence, the vehicle has the advantage that due to the possibility of measuring the C—H-gas concentration of the fluid volume flow that flows from the first line end towards the second line end, an amount of C—H-gas provided to the combustion engine via the purge system can be determined. Thus, the amount of fuel injected into the combustion engine can be adjusted based on this information in order to operate the combustion engine with an optimized mixture of C—H-gas and air. Consequently, an additional optimization of the combustion process by means of the lambda probe requires less adjustment of fuel injection amount and air feeding. This has the advantage, that energy consumption and CO2 emissions can be reduced significantly. Moreover, by these means, the purge process can be further improved, since the time window for purging can be increased.

The invention also provides a method for operating a combustion engine system of a vehicle with a purge system according to the invention. The method can comprise: measuring a C—H-gas concentration of a fluid volume flow that flows from the first line end towards the second line end of the purge system by the C—H-sensor; determining a fluid volume flow that flows from the first line end towards the second line end by the control unit; determining a C—H-gas volume flow from the measured C—H-gas concentration and the determined fluid volume flow by the control unit; and/or adapting a fuel injection to the combustion engine with respect to the determined C—H-gas volume flow.

The C—H-gas concentration can be measured by at least one C—H-gas sensor, for example a C—H-gas sensor that is integrated in a purge pump of the purge system. The measurement is performed within a mix of air and C—H-gas from the tank system. The result of the measurement is provided to the control unit. The fluid volume flow is a sum of a C—H-gas volume flow and an air volume flow, flowing through the gas connection lines from the first line end towards the second line end. The fluid volume flow can be determined by evaluating a rotational speed of the purge pump or by pressure measurements and a setting of the purge valve. The result of the determination of the fluid volume flow is provided to the control unit. Preferably by means of the control unit, the C—H-gas volume flow is determined, e.g. calculated, from the measured C—H-gas concentration and the determined fluid volume flow. Thus, an amount of C—H-gas that is provided to the induction line within a time unit is determined. Based on this information, this amount of C—H-gas is deducted from the fuel injection to the combustion engine. In other words, an amount of C—H that is provided to the combustion engine via the purge system is reduced from the amount of injected fuel in order to maintain an optimized combustion process. Further adjustment can be made based on results of measurements by the lambda probe.

The method according to the invention has the same advantages over the prior art as previously described with regard to the purge system according to the first aspect of the invention and the vehicle according to the second aspect of the invention. Hence, the method has the advantage that due to the determination of the amount of C—H-gas provided to the combustion engine via the purge system, the amount of fuel injected into the combustion engine can be adjusted, respectively, in order to operate the combustion engine with an optimized mixture of C—H-gas and air. Consequently, an additional optimization of the combustion process by means of the lambda probe requires less adjustment of fuel injection amount and air feeding. This has the advantage, that energy consumption and CO2 emissions can be reduced significantly. Moreover, by these means, the purge process can be further improved, since the time window for purging can be increased.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows an exemplary embodiment of a vehicle according to the invention in a top view;

FIG. 2 schematically shows an exemplary embodiment of a purge system according to the invention; and

FIG. 3 schematically shows a flow chart of the method according to an exemplary embodiment of the invention.

### DETAILED DESCRIPTION

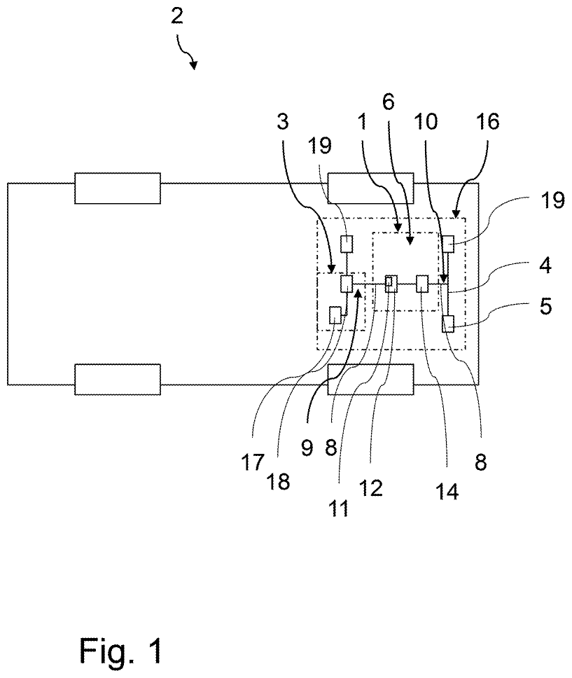

In FIG. 1, an exemplary embodiment of a vehicle 2 according to the invention is schematically illustrated in a top view. The vehicle 2 comprises a combustion engine system 16. The combustion engine system 16 comprises a tank system 3 with a fuel tank 17 and an active carbon filter 18 for binding C—H-gas evading from the tank 17. An air filter 19 of the combustion engine system 16 is connected with the active carbon filter 18 for providing filtered air for flushing the active carbon filter 18. The active carbon filter 18 is connected to a first line end 9 of a gas connection line 8 of a purge system 1 of the combustion engine system 16. The gas connection line 8 connects the tank system 3 with a purge unit 6 of the purge system 1. The purge unit 6 comprises a purge pump 12 and a purge valve 14 that are arranged in line, wherein the purge valve 14 is arranged downstream the purge pump 12 with respect to a fluid flow direction through the purge system 1. The purge unit 6 may further comprise an optional, check valve 13 that is preferably arranged downstream the purge valve 14 of the purge system 1. A second line end 10 of a gas connection line 8 of the purge system 1 is connected with an induction line 4 of the combustion engine system 16. One end of the induction line 4 is connected with an air filter 19 for providing filtered air to the induction line 4. Another end of the induction line 4 is connected to a combustion engine 5 of the combustion engine system 16.

The purge unit 6 can just comprises a purge pump 12 and a check valve 13, wherein the check valve 13 can be arranged downstream the purge pump 12. According to a further exemplary embodiment, the purge unit 6 just comprises a purge valve 14 and check valve 13, wherein preferably, the check valve is located downstream the purge valve 14.

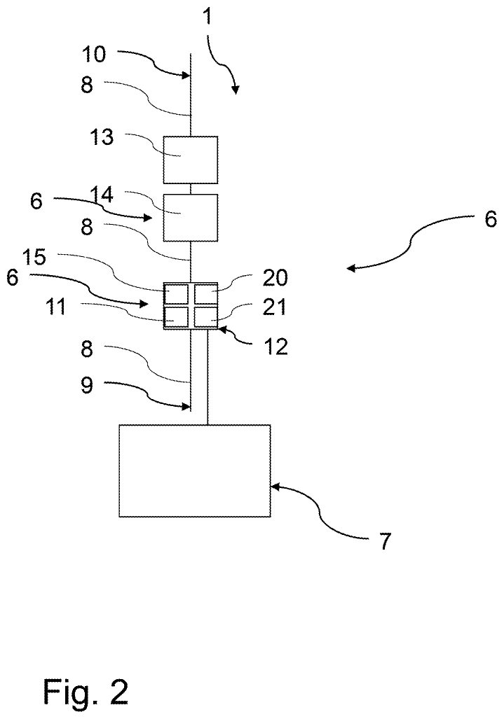

In FIG. 2, an exemplary embodiment of a purge system 1 according to the invention is schematically illustrated. The purge system 1 comprises a purge pump 12 for pumping C—H-gas from a tank system 3 (c.f. FIG. 1) via a gas connection line 8, a purge valve 14 and an optional check valve 13 of the purge system 1 to a induction line 4 (c.f. FIG. 1) of the combustion engine system 16 (c.f. FIG. 1). For pumping the C—H-gas, the purge system 1 comprises a motor. The purge system 1 further comprises a control unit 7 for operating the motor of the purge pump 12. According to this preferred embodiment, the purge system 1 further comprises a C—H-sensor 11, a pressure sensor 15, a mass flow sensor 20 and a temperature sensor 21 are integrated with the purge pump 12. Alternatively, the C—H-sensor 11 and/or the pressure sensor 15 and/or the mass flow sensor 20 and/or the temperature sensor 21 can be arranged somewhere at the gas connection line 8 and/or at the purge valve 14 and/or the optional check valve 13. In an alternative embodiment, the temperature sensor 21 can be integral with another sensor, e.g. the pressure sensor 15 or the mass flow sensor 20.

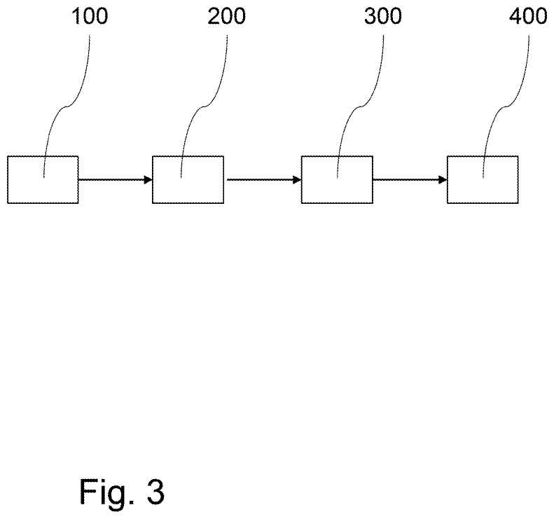

In FIG. 3, a method according to the invention is illustrated in a flow chart. In a first step 100, the C—H-gas concentration of the fluid volume flow that flows from the first line end 9 towards the second line end 10 of the purge system 1 is measured by the C—H-sensor 11. In a second step 200, the fluid volume flow that flows from the first line end 9 towards the second line end 10 is determined by the control unit 6, e.g. by measuring pressure by means of the pressure sensor 15 or by identifying a rotational speed of the purge pump 12. The fluid comprises air and C—H-gas. In a third step 300, C—H-gas volume flow is determined by the control unit from the measured C—H-gas concentration and the determined fluid volume flow. Thus, an amount of C—H-gas that is fed to the induction line 4 per time period is determined. In a fourth step 400, a fuel injection to the combustion engine 5 is adapted with respect to the determined C—H-gas volume flow. This can be done by the control unit 7. This means, that the amount of C—H-gas that is fed to the induction line 4 is reduced from the fuel feeding to the combustion engine 5. The higher the C—H-gas volume flow into the induction line 4, the less fuel is injected to the combustion engine 5. Thus, a total amount of C—H that is fed to the combustion engine 5 remains the same, independent from the amount of C—H-gas fed to the induction line 4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A purge system of a vehicle for purging C—H-gas of a tank system to an induction line of a combustion engine of the vehicle, the purge system comprising:
a purge unit;
a control unit for operating the purge unit and a gas connection line, a first line end of the gas connection line is configured for connecting the purge unit with the tank system and a second line end of the gas connection line is configured for connecting the purge unit with the induction line; and
a C—H-sensor for measuring a C—H-gas concentration of a fluid volume flow that flows from the first line end towards the second line end.

2. The purge system according to claim 1, wherein the purge unit comprises a purge pump for purging C—H-gas from the first line end towards the second line end.

3. The purge system according to claim 1, wherein the purge system further comprises a check valve for preventing a fluid flow from the induction line towards the purge pump.

4. The purge system according to claim 1, wherein the purge unit comprises a purge valve for controlling a volume flow of C—H-gas from the first line end towards the second line end.

5. The purge system according to claim 1, wherein the C—H-sensor is integrated in the purge pump or the check valve or the purge valve.

6. The purge system according to claim 1, wherein the purge unit comprises a pressure sensor and/or a mass flow sensor for measuring a fluid pressure and/or a fluid mass flow inside the gas connection line between the purge unit and the first line end and/or a temperature sensor for measuring a temperature within the purge system.

7. The purge system according to claim 6, wherein the pressure sensor and/or mass flow sensor and/or the temperature sensor is integrated in the purge pump or the purge valve.

8. The purge system according to claim 1, wherein the control unit is configured to determine a C—H-gas volume flow that exits the second line end, based on the measured C—H-gas concentration and the fluid volume flow through the gas connection lines.

9. A vehicle comprising:
a combustion engine;
a tank system for providing the combustion engine with fuel;
an induction line for providing the combustion engine with oxygen; and
a purge system according to claim 1.

10. A method for operating a combustion engine system of a vehicle with a purge system according to claim 1, the method comprising:
measuring by the C—H-sensor a C—H-gas concentration of a fluid volume flow that flows from the first line end towards the second line end of the purge system;
determining a fluid volume flow that flows from the first line end towards the second line end by the control unit;
determining a C—H-gas volume flow from the measured C—H-gas concentration and the determined fluid volume flow by the control unit; and
adapting a fuel injection to the combustion engine with respect to the determined C—H-gas volume flow.
